(19) United States
(12) Patent Application Publication
(10) Pub. No.: US 2016/0086177 A1
(43) Pub. Date: Mar. 24, 2016

(54) Smart Gross Management of Repairs and Exceptions for Payment Processing

(71) Applicant: Bank of America Corporation, Charlotte, NC (US)

(72) Inventors: Sarah T. Billings, Chicago, IL (US); Doug J. Carlson, New York, NY (US); Laura P. Misenheimer, Waxhaw, NC (US); Chaitesh Shah, Charlotte, NC (US)

(21) Appl. No.: 14/858,785

(22) Filed: Sep. 18, 2015

Related U.S. Application Data
(60) Provisional application No. 62/052,403, filed on Sep. 18, 2014.

(51) Int. Cl. G06Q 20/40; G06Q 20/24

(52) U.S. Cl. CPC G06Q 20/401; G06Q 20/4033; G06Q 20/24

(57) ABSTRACT

Methods and systems for providing smart gross management of repairs and exceptions for payment processing are presented. In some embodiments, a computing device may receive data regarding a plurality of payment transactions involving a client account of a financial institution. Subsequently, the computing device may identify one or more rejected and/or otherwise defective transactions in the plurality of transactions. After identifying such rejected transactions, the computing device may create an account entry for an amount corresponding to the plurality of transactions. Notably, such an account entry may be created, and a corresponding debit or credit may be made, prior to initiating repairs for the rejected transactions. After creating the account entry, the computing device may initiate repairs for the rejected transactions. The computing device also may send a notification indicating that the amount corresponding to the plurality of transactions has been debited or credited to the client account.

### CROSS-REFERENCE TO RELATED APPLICATIONS

This application claims the benefit of U.S. Provisional Patent Application Ser. No. 62/052,403, filed Sep. 18, 2014, and entitled “Smart Gross Accounting,” which is incorporated by reference herein in its entirety.

### BACKGROUND

For many organizations, managing transactions and keeping track of payments may be of paramount importance. Organizations such as financial institutions may process payments from various clients in connection with contracts or agreements for processing different transactions. For example, client payments may be processed through payment platforms to provide standardized management and processing of payments as well as transfer of funds. In some cases, financial institutions may desire to implement straight through processing for client payments. A straight through processing environment may allow for faster processing of transactions by electronic transfer of information without manual processes for entering information.

In some cases, one or more payments may be rejected by traditional payment platforms that enable straight through processing. For example, there may be errors in routing information associated with payments, such as an incorrect or incomplete client account number for a client's account with a financial institution. A traditional payment platform may reject such payments and forgo processing of the rejected payments. However, these payments may be valid and may necessitate adjustments by the financial institution to the client's account after being rejected by the traditional payment platform. These adjustments may be inconvenient and frustrating for the client and may create difficulties and inefficiencies for the financial institution and its computer systems.

### SUMMARY

The following presents a simplified summary in order to provide a basic understanding of some aspects of the disclosure. This summary is not an extensive overview of the disclosure. It is intended neither to identify key or critical elements of the disclosure nor to delineate the scope of the disclosure. The following summary merely presents some concepts of the disclosure in a simplified form as prelude to the description below.

Aspects of the disclosure relate to various systems and techniques that provide effective, efficient, scalable, and convenient ways of processing payments and providing smart gross management of repairs and exceptions for payment processing, particularly in ways that may enable an organization (e.g., a financial institution) and its computer systems to improve accounting for client payments, as well as in ways that make accounting and payment processing more efficient for such organizations. Improvements in payment processing and accounting may be beneficial for reconciliation of client accounts, as a reduced number of adjustments for client accounts and a reduced customer service work load for the financial institution may be provided by such improvements. Improvements in payment processing and accounting may also provide benefits to the clients of the financial institution.

In one or more embodiments, a computing device that includes at least one processor, a communication interface, and a memory storing computer-executable instructions may receive, via the communication interface and from one or more computing devices, data regarding a plurality of payment transactions to be made from a client account in a financial institution (which may, e.g., include data corresponding to transactions originating by the financial institution on a client's behalf). Subsequently, the computing device may identify and/or otherwise determine one or more rejected payment transactions in the plurality of payment transactions based on the data regarding the plurality of payment transactions for the client account (which may, e.g., include data corresponding to payment transactions originated by the financial institution on behalf of a client associated with the client account). In one or more arrangements, rejected payment transactions refers to one or more payment transactions that may potentially necessitate repair or review, for instance, because they have one or more defects or may otherwise be considered exceptions. Additionally, in one or more arrangements, repairing a rejected payment transaction may refer to applying a fix, a change, a review, an enrichment (e.g., an automated repair), or the like to the rejected payment transaction and/or the data associated with the rejected payment transaction. After identifying and/or otherwise determining the one or more rejected payment transactions in the plurality of payment transactions, the computing device may create an account entry for an amount corresponding to the plurality of payment transactions, where the amount is debited to the client account, or the amount may be credited for direct debit transactions. Notably, such an account entry may be created, and a corresponding debit or credit may be made, prior to initiating one or more repairs for the one or more rejected payment transactions, so as to increase convenience for the client(s) of the financial institution. After creating the account entry, the computing device may initiate a repair for each of the one or more rejected payment transactions in the plurality of payment transactions. Simultaneously, or substantially contemporaneously, the computing device may send, via the communication interface and to the one or more computing devices, a notification indicating that the amount corresponding to the plurality of payment transactions has been debited or credited to the client account. For example, the computing device may send the notification to the one or more computing devices prior to the repair of each of the one or more rejected payment transactions in the plurality of payment transactions. In some instances, the computing device also may issue notifications at other points in performing its processing.

In some embodiments, determining the one or more rejected payment transactions may include identifying one or more errors in at least one of the plurality of payment transactions, and the one or more errors identified in the at least one of the plurality of payment transactions may include one or more unrecoverable errors and/or one or more recoverable errors. In some instances, an unrecoverable error may be or correspond to the existence of a duplicate payment transaction or a non-existent account number for a transaction. In some instances, a recoverable error may be or correspond to the existence of incorrect routing information or incomplete routing information.

In some embodiments, prior to initiating the repair for each of the one or more rejected payment transactions, the computing device may identify whether each of the one or more rejected payment transactions are repairable.

In some embodiments, the computing device may identify at least one recoverable error for repair for each of the one or more rejected payment transactions. Subsequently, the computing device may determine each of the one or more rejected payment transactions to be repaired based on the at least one recoverable error. Thereafter, the computing device may complete the repair for each of the one or more rejected payment transactions.

In some embodiments, the computing device may identify at least one unrecoverable error for each of the one or more rejected payment transactions. Subsequently, the computing device may identify one or more rejected payment transactions as irrepairable payment transactions based on the rejected payment transactions having at least one unrecoverable error. Thereafter, the computing device may apply an adjustment for each of the irrepairable payment transactions, which may result in a client account posting.

In some embodiments, the computing device may determine that the repair for each of the one or more rejected payment transactions has been completed.

In some embodiments, creating the account entry for the amount corresponding to the plurality of payment transactions may be based on an expectation that the one or more rejected payment transactions will be cleared, repaired, validated, approved, or the like, in a predetermined period of time.

In some embodiments, the rejected payments may be rejected based on the existence of incorrect routing information or incomplete routing information for the client account. In additional or alternative embodiments, in repairing each of the one or more rejected payment transactions, the computing device may process client account information, validate payments, and/or correct routing information for the client account.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various illustrative aspects of the present disclosure may be implemented.

FIG. 2 depicts an illustrative block diagram of workstations and servers that may be used to implement the processes and functions of aspects of the present disclosure.

FIG. 3 depicts an example of a computing environment that includes a system for smart gross management of repairs and exceptions for payment processing according to one or more illustrative aspects of the disclosure.

FIGS. 4A and 4B illustrate flowcharts that depict methods of smart gross management of repairs and exceptions for payment processing according to one or more illustrative aspects of the disclosure.

FIGS. 5A and 5B illustrate flowcharts that depict additional methods of smart gross management of repairs and exceptions for payment processing according to one or more illustrative aspects of the disclosure.

FIGS. 6A, 6B, and 6C depict an illustrative table that includes example data associated with smart gross management of repairs and exceptions for payment processing according to one or more illustrative aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

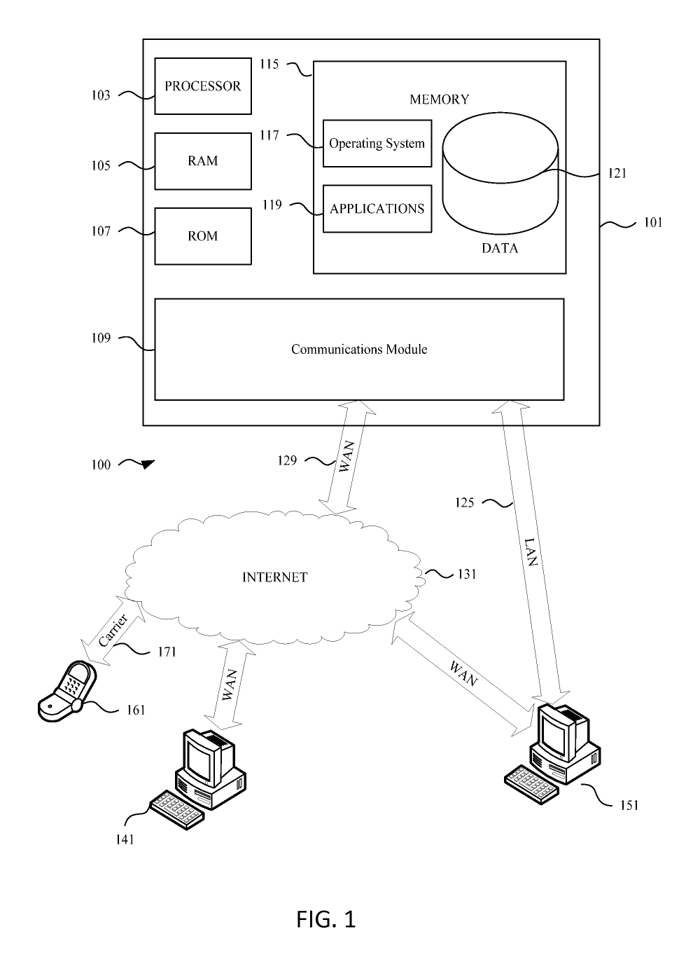

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audio visual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

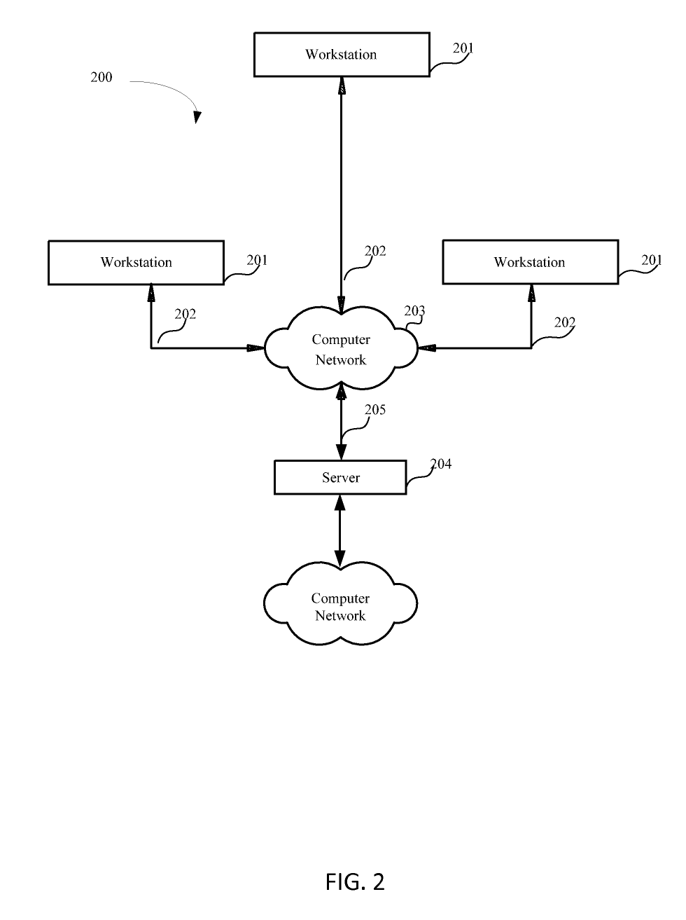

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

Having described an example of a computing device that can be used in implementing various aspects of the disclosure and an operating environment in which various aspects of the disclosure can be implemented, several illustrative embodiments will now be discussed in greater detail. As introduced above, some aspects of the disclosure generally relate to various systems and techniques that provide effective, efficient, scalable, and convenient ways of processing payments and managing repairs by utilizing smart gross processing, particularly in ways that may enable an organization to provide global consistency in accounting for client payments.

Some methods for payment transaction processing may employ net accounting models, in which client accounts may only show payment transactions that have been successfully processed through a payments platform processing workflow and are ready to be sent to a payment transaction clearing system (e.g., a clearing house system). These payment transactions and the resulting accounting entries may exclude any transactions that initially or permanently fail one or more of the multiple validations and screenings of the transactions that typically take place before accounting entries are created and corresponding funds are credited to and/or debited from one or more accounts. For example, a financial institution may receive a high-volume group of payment transactions, such as a thousand payment transactions to be performed in connection with a particular client account (e.g., an account of a client or customer of the financial institution that is maintained by the financial institution on behalf of the client or customer). In some cases, one or more of the one thousand payment transactions in the high volume group of payment transaction may be rejected (e.g., as a result of recoverable or unrecoverable errors in such payment transactions). For example, ten of one thousand payment transactions in the group may be rejected, resulting in only the subtotal of 990 of the one thousand payment transactions being debited or credited to the client account (e.g., a consolidated debit or credit for 990 individual payment transactions). Payment transactions may be rejected for various reasons, and some rejections may be appropriate and/or unrecoverable, while other rejections may be repaired and thus may be considered recoverable errors. In the case of recoverable errors, a payment may in fact be valid and may be rejected for one or more recoverable errors, such as incorrect or incomplete routing information, which may be fixed. In other cases, a payment may be properly rejected for an unrecoverable error, such as a duplicate payment, a non-existent account number for a transaction, or the like. In the cases in which one or more valid payment transactions are rejected for a recoverable error, the rejected payment transactions may necessitate repair and additional accounting adjustments to the client account in order to clear the payment transactions.

Furthermore, the accounting adjustments may result in an increased number of accounting entries in the client account because each repaired payment transaction in a group of transactions may be settled as a single item on a client account. For example, each payment of 10 rejected payment transactions (e.g., out of 1,000 payment transactions) may be one dollar. Upon repair, the client may receive 10 individual adjustment entries for one dollar each on his or her client account for the 10 rejected payment transactions (e.g., 10 adjustments are shown on the client account). This process may be cumbersome from a reconcilement standpoint for clients with hundreds or thousands of transactions, where each transaction may be for large amounts of money. Additionally, each of the payment transactions in a group of client payment transactions may be for different amounts (e.g., thousands or millions of dollars) and for different purposes (e.g., payment transactions for payroll as opposed to payment transactions for vendor payment), and clients may be sending hundreds or thousands of payment transactions to the financial institution for processing daily, weekly, monthly, or the like. It may be difficult for clients to keep track of amounts and numbers corresponding to which payment transactions have been rejected, which payment transactions have been cleared, which payment transactions are in processing, and the like. Thus, conventional payment platform methods may be inefficient in properly processing payment transactions, resulting in an increased number of accounting entries for each client account (e.g., adjustments and/or reversals) beyond a reasonable threshold.

Therefore, one or more aspects of the present disclosure provide a smart gross processing model for processing payment transactions and repairing rejected payment transactions for financial institutions. Smart gross processing may account for payment transactions that have been rejected during processing but are subject to repair, resulting in fewer accounting entries for client accounts. Smart gross processing may include assuming that rejected payment transactions in a group of transactions may be repaired during processing because of recoverable errors. For example, if 10 payment transactions are rejected out of 100 payment transactions, smart gross processing may allow the financial institution to determine a reason for rejection (e.g., unrecoverable error or recoverable error) and determine if each of the rejected transactions may be repaired. Thus, in this example, the financial institution may still create a settlement entry for the full 100 payment transactions because it may be assumed that the 10 rejected payment transactions may be processed and repaired in a predetermined period of time set by the financial institution (e.g., a window of time before the payment is to be cleared). In other words, it may be understood that the 10 rejected payment transactions are due to recoverable errors which may be repaired during processing.

Smart gross processing may rely on pre-processing that involves validation to indicate whether a rejected payment transaction (which may, e.g., be a payment transaction having one or more defects and/or which is otherwise considered an exception) is recoverable or unrecoverable. In some embodiments, payment transactions may be rejected due to unrecoverable errors and/or recoverable errors. In other embodiments, payment transactions may be rejected due to failing client settings. For example, client settings may include predefined standards set within the financial institution for specific clients. In one or more arrangements, client settings may be referred to as client setup parameters or client settings. In some cases, clients may define and/or otherwise set up settings for repair or no repair. In other cases, rather than a client defining such settings, the financial institution may define and/or otherwise set up such settings for repair and/or no repair for one or more specific clients. Based on a particular client's settings for repair and/or the financial institution's settings for repair (e.g., a “repair” setting or “no repair” setting for the particular client), rejected payment transactions may be repaired and cleared properly so that the rejected payment transactions are not returned to the client for failing payment processing or payment validation. If, in the example above, for instance, any of the 10 rejected payment transactions are not repaired, then the unrepaired payment transactions may be reversed accordingly via an adjustment applied to the corresponding client account by the financial institution.

By implementing smart gross processing in accordance with one or more aspects of the present disclosure, accounting and payment processing may be made more efficient for financial institutions and their clients. For example, any rejected payments that are considered to be recoverable may be included in the settlement entry to the client's account, and reversals and/or adjustment entries may be posted to the client account in the event that the rejected transaction cannot be repaired. Additionally, client accounts may each reflect a reduced number of adjustments, because multiple adjustments associated with a single group of payment transactions can be accounted for in a single entry. A high number of adjustments on a client account may result in confusion and more questions from clients or customers, and a reduced number of adjustments on a client account may minimize the number of questions from customers voicing their concerns to the financial institution. In this way, improvements in payment processing and accounting may be beneficial to both to the client and to the financial institution by reducing confusion and frustration for clients while also reducing a customer service work load for the financial institution. Thus, improvements in payment processing and accounting not only provides benefits to the financial institution, but may also provide benefits to the clients of the financial institution. In the discussion below, various examples illustrating processing payments and managing repairs with smart gross processing computer systems in accordance with one or more embodiments will be provided.

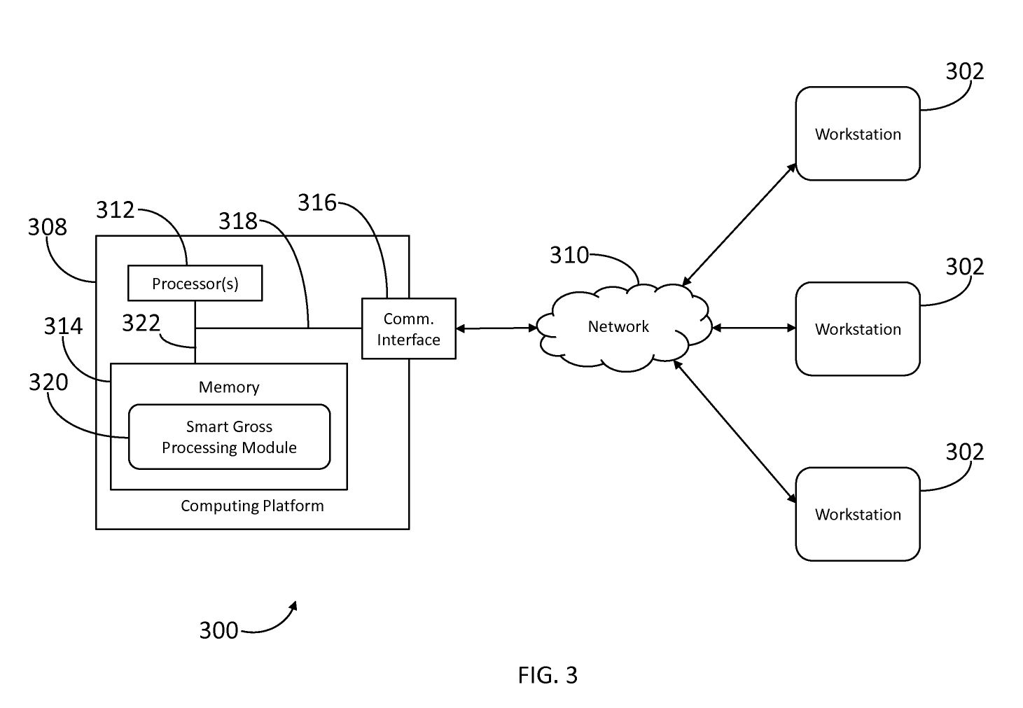

FIG. 3 depicts an illustrative computing environment for smart gross management of repairs and exceptions for payment processing in accordance with one or more example embodiments. Referring to FIG. 3, computing environment 300 may be used for implementing example embodiments according to the present disclosure and may include one or more computing devices. For example, computing environment 300 may include computing platform 308 and a plurality of workstations 302 connected by network 310.

According to one or more aspects, computing environment 300 may be associated with a financial institution, such as a bank. Various elements may be located within the financial institution and/or may be located remotely from the financial institution. For instance, one or more workstations 302 may be located within a branch office of a financial institution. Each workstation 302 may be used, for example, by a customer service representative, financial advisor, financial trader, branch manager, or another employee of the financial institution in managing financial accounts and transactions via network 310. Additionally or alternatively, one or more workstations 302 may be located at a user location (e.g., at an employee's home). In some embodiments, there may be any number of workstations 302 in computing environment 300. Workstations 302 may be the same as workstations 201 illustrated in system 200. In other embodiments, one or more workstations 302 may be employed by customers or clients of the financial institution. For example, clients may include commercial vendors of the financial institution. In some embodiments, clients may use one or more workstations 302 to submit data regarding payment transactions to the financial institution. Computing environment 300 may also include one or more networks, which may interconnect one or more of workstations 302 and/or computing platform 308. For example, computing environment 300 may include network 310. Network 310 may include one or more sub-networks (e.g., LANs, WANs, VPNs, or the like).

Computing environment 300 may also include one or more computing platforms. For example, computing environment 300 may include computing platform 308. Computing platform 308 may include one or more of any type of computing device (e.g., desktop computer, laptop computer, tablet computer, smart phone, server, server blade, mainframe, virtual machine, or the like) configured to perform one or more of the functions described herein. Computing platform 308 may include one or more processor(s) 312, memory 314, communication interface 316, and/or data bus 322. Data bus 322 may interconnect processor(s) 312, memory 314, and/or communication interface 316. Communication interface 316 may be a network interface configured to support communication between computing platform 308 and network 310 (or one or more sub-networks thereof). Memory 314 may include one or more program modules comprising instructions that when executed by processor(s) 312 cause computing platform 308 to perform one or more functions described herein. For example, memory 314 may include a smart gross processing module 320, which may include instructions that when executed by processor(s) 312 cause computing platform 308 to perform one or more functions described herein.

Smart gross processing module 320 may be integrated with one or more program modules that may perform payment processing, accounting, financial screening, and repairs for a financial institution. That is, smart gross processing module 320 may interface with program module(s) and/or other computing platform(s) for processing and repairing payments. For example, smart gross processing module 320 and/or computing platform 308 may interface with one or more payment processing engines or modules and/or workstations 302. In some embodiments, computing platform 308 may receive a plurality of payment transactions from a client at a workstation 302. A payment transaction may consist of a credit transfer or a direct debit. A credit transfer may occur when funds are transferred from one financial account to another financial account, while a direct debit may occur when a corporation or organization withdraws funds from another corporation's or individual's bank account.

Upon receiving the plurality of payment transactions (e.g., from a workstation 302 or one or more workstations 302), computing platform 308 may initiate processing, and this processing may be divided into pre-processing and core processing (which may, e.g., include a more thorough processing procedure after the initial pre-processing is performed). For example, in one or more embodiments, the computing platform 308 may initially perform pre-processing with respect to one or payment transactions, and after performing such pre-processing, the computing platform 308 may continue subsequently perform core processing of the payment transactions. In performing pre-processing, the computing platform 308 may perform an initial validation to determine if there are any errors in the payment transactions included in the plurality of payment transactions, such as recoverable errors or unrecoverable errors in such payment transactions. For example, errors may include the existence of one or more typographical errors in the plurality of payment transactions, such as the existence of an incorrect routing address or an incorrect client or beneficiary account number. Errors may also include the existence of incorrect or incomplete routing information in the plurality of payment transactions, such as incorrect or incomplete routing information for an intermediary bank associated with a beneficiary bank. These errors may be unintentional and may be recoverable. The computing platform 308 may identify an error in a payment transaction and may flag the payment transaction for repair. That is, computing platform 308 may identify an error based on parsing data regarding the payment transaction and performing various validation processes, such as checking routing databases, field lengths, invalid characters, compliance databases, and the like.

For example, the computing platform 308 may check text fields in the data received for a payment transaction and may identify whether or not one or more text fields representing an account number at a beneficiary institution include enough characters. In another example, the computing platform 308 may identify if one or more text fields include alpha characters, such as in a case where alpha characters might not be permitted (e.g., such as for an account number). In yet another example, the computing platform 308 may determine that the account number listed in a payment transaction does not match with a specific client account number. Thus, the computing platform 308 may identify this mismatch as an error and mark the payment transaction for additional processing or mark the payment transaction as a rejected payment transaction. In another example, the computing platform 308 may identify an error based on validation with predefined metrics and/or compliance with local, national, and/or international laws. In some embodiments, computing platform 308 may reject a payment transaction due to client settings, which may be predetermined and set by the client and/or by the financial institution, as discussed above. In some instances, in performing core processing, computing platform 308 may perform one or more of the same checks as performed in pre-processing.

Recoverable errors may refer to errors that may be repaired, whereas unrecoverable errors may refer to errors that might not be repaired in the payment transactions and may result in such payment transactions being rejected. For example, an unrecoverable error may correspond to the occurrence of a duplicate payment (e.g., when a client pays for a particular invoice more than once). Additionally or alternatively, a financial institution may err in processing a payment transaction more than once (e.g., twice or more). Another example of an unrecoverable error that may occur in a payment transaction is the existence of a reference to a client account number that does not exist within the financial institution.

Upon identifying one or more unrecoverable errors, the computing platform 308 may identify one or more rejected payment transactions in the plurality of payment transactions as being irrepairable and might not continue to process the rejected payment transactions. The computing platform 308 may notify the client of the rejected payment transactions that are not debited or credited to the client account. In some cases, the computing platform 308 may identify errors in payment transactions to be repairable or recoverable. However, after further processing, the smart gross processing module 320 may reevaluate and identify these errors as irrepairable or unrecoverable errors in the payment transactions. In such cases, the smart gross processing module 320 may apply an adjustment for each of the irrepairable payment transactions, which were previously identified as repairable payment transactions. The smart gross processing module 320 may apply an adjustment by posting an entry (e.g., a dollar amount) to a corresponding client account for an irrepairable payment transaction. For example, the smart gross processing module 302 may post a credit to the client account. Upon identifying one or more recoverable errors, the computing platform 308 may proceed to repair each of the recoverable errors in corresponding rejected payment transactions. The adjustments made to client accounts are described herein in the context of a credit to the client account. It will be appreciated, however, that the adjustment may also be a debit to the client account in some instances.

In some embodiments, during pre-processing and/or core processing, computing platform 308 may validate each of the payment transactions and implement certain forms of automated repair including, for example, payment enrichment. Payment enrichment may involve payment attributes enrichment and/or beneficiary account enrichment derivation (e.g., such as enrichment of beneficiary account details, including international bank account number enrichment). Payment enrichment may include adding information, such as account details, to a payment transaction to enrich the data regarding the payment transactions.

Even after identifying one or more recoverable errors in the payment transactions, the computing platform 308 may identify and/or otherwise determine that there are still additional problems or errors with certain payment transactions during core processing. Thus, smart gross processing module 320 may issue a reversal of a transaction (e.g., a debit if the client was previously credited, or a credit if the client was previously debited) to the client account for each payment transaction with a problem or error that might not be fixed or repaired within a certain time period. The client account may have a reduced number of adjustments because of the pre-processing implemented by computing platform 308 which may exclude any unrecoverable rejected payments.

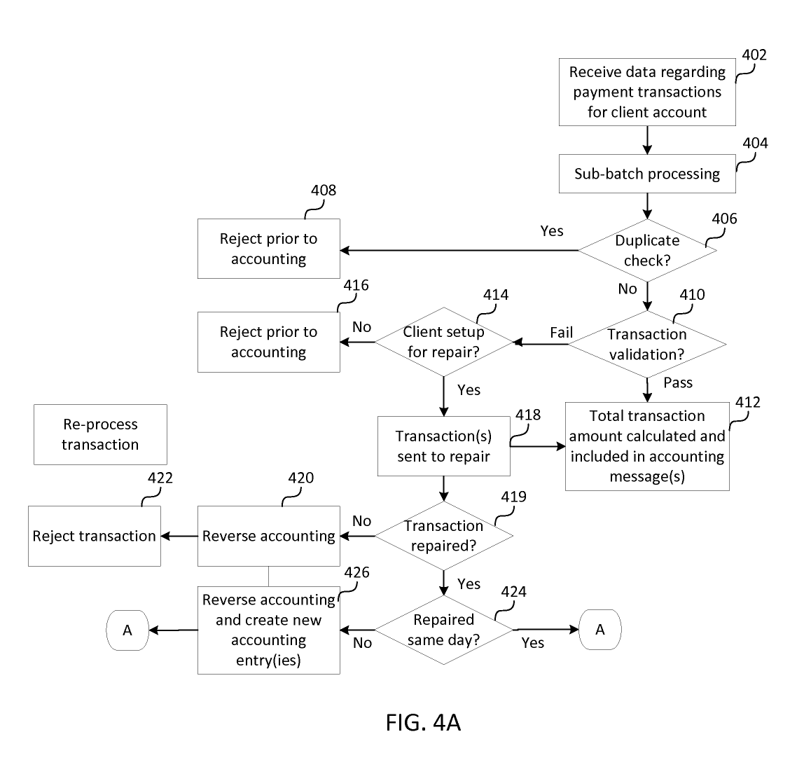

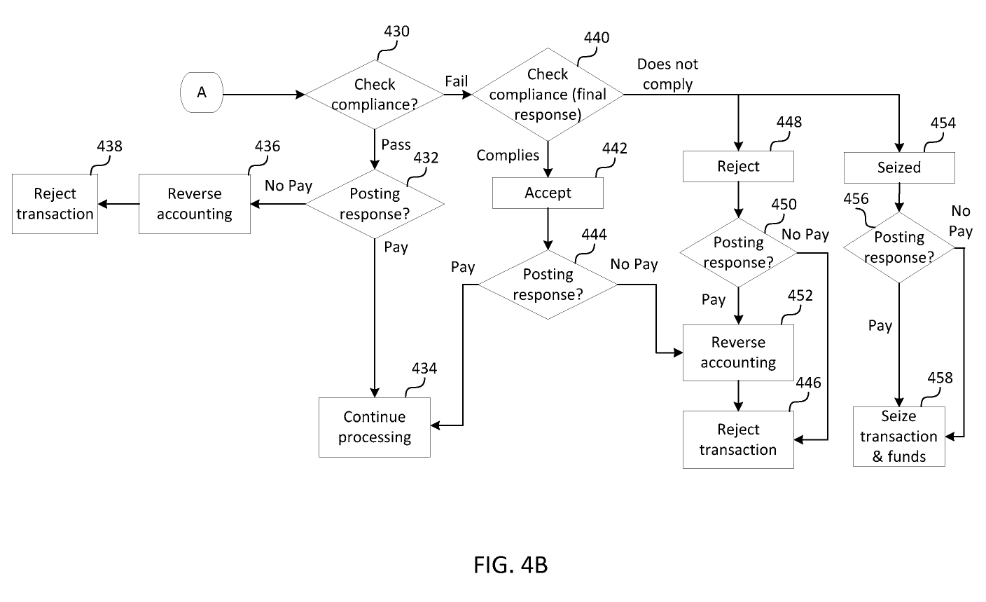

The systems (e.g., system 100, system 200, and/or computing environment 300) described above may be used in processing and repairing payments for smart gross processing. An example of a method that may be performed (e.g., in some embodiments by one or more computing devices included in computing environment 300) will now be discussed in greater detail with respect to FIGS. 4A and 4B.

FIGS. 4A and 4B illustrate flowcharts that depict methods of smart gross management of repairs and exceptions for payment processing according to one or more aspects of the disclosure. In some embodiments, the example methods illustrated in FIGS. 4A and 4B may be performed by a computing device, which may include and/or implement one or more aspects of computing device 101. In additional and/or alternative embodiments, the example methods illustrated in FIGS. 4A and 4B may be performed by a computer system, such as a server computer system that is owned, operated, and/or controlled by a financial institution (which may, e.g., maintain the computer system in a back office or data center to process and repair payments for smart gross processing), and such a computer system may include one or more computing devices that include and/or implement one or more aspects of computing device 101 and/or computing platform 308. In other embodiments, the example methods illustrated in FIGS. 4A and 4B may be implemented in and/or may otherwise be embodied in non-transitory computer-readable instructions that may be stored in a computer-readable medium, such as a memory (disk drive, hard drive, solid state memory, optical drive, and the like). Moreover, it will be appreciated that the process shown in FIGS. 4A and 4B is an illustration and that the process can take other forms to achieve the same purpose. For example, the steps shown in FIGS. 4A and 4B may be performed in any order other than the recited order and that one or more of the steps may be performed in parallel.

As seen in FIG. 4A, the method may be initiated at step 402, in which data may be received regarding payment transactions for a client account. For example, at step 402, computing platform 308 may receive data regarding a plurality of payment transactions for a client account in a financial institution from one or more workstations 302. Each of the workstations 302 may be associated with a client or an employee of the financial institution. For example, computing platform 308 may receive the data from a workstation 302 within a group of workstations 302, in which the workstations 302 correspond to a specific work group of employees in a financial institution. For example, a group of employees may be associated with a particular department in the financial institution, and the computing platform 308 may receive the data from one or more workstations 302 within the department. Data regarding the plurality of payment transactions may include account information, such an amount for each of the payment transactions, account number, client name, client address, and the like.

The method of FIG. 4A may continue to step 404 for sub-batch processing of the data regarding the plurality of payment transactions. For example, at step 404, computing platform 308 may perform sub-batch processing of the data regarding the plurality of payment transactions. In some embodiments, in performing sub-batch processing at step 404, computing platform 308 may process the data in a batch or a group of payment transactions for a single client account. That is, the system may be directed to handling groups of payment transactions for a client, rather than individual payment transactions for a client. In some embodiments, the plurality of payment transactions may be made out to one or more beneficiaries as designated by the client. The computing platform 308 may also handle multiple batches of payment transactions for any number of clients.

At step 406, computing platform 308 may proceed to a duplicate checking of the plurality of payment transactions. That is, at step 406, computing platform 308 may check the payments and determine if there are any duplicate payment transactions. The computing platform 308 may conduct duplicate checking to prevent or avoid duplicate accounting entries in client accounts. For example, there may be an error in a financial institution's files or duplicate transactions, which may result in the client being charged more than once. In this example, computing platform 308 may identify a payment transaction as a duplicate accounting entry. In another example, the financial institution may desire to check for duplicate transactions in order to prevent mistakenly processing a payment transaction twice. In this example, computing platform 308 may identify any duplicate transactions and refrain from processing any such duplicate transactions more than once so as to avoid mistakenly processing a particular payment transaction twice.

If the computing platform 308 determines that there are one or more duplicate transactions, then the method in this example proceeds to step 408, in which the computing platform 308 rejects one or more duplicate transactions prior to accounting. For example, at step 408, computing platform 308 may reject the one or more duplicate transactions prior to accounting. That is, computing platform 308 may properly reject one or more of the payment transactions due to an unrecoverable error (e.g., because the one or more payment transactions are duplicate transactions), and computing platform 308 may notify the client of the rejected payment transactions. For example, in rejecting the one or more duplicate transactions, computing platform 308 may send a notification to one or more workstations 302. However, if the computing platform 308 determines that there are no duplicate transactions or at least one or more transactions that are not duplicate transactions, then the method in this example proceeds to step 410. At step 410, the computing platform 308 may validate the payment transactions. For example, at step 410, the computing platform 308 may validate the payment transactions by determining whether the transactions meet various standards, such as by checking or parsing the syntax, fields, and/or format of the data regarding the payment transactions. For example, the computing platform 308 may determine if a client account number and/or routing number of a particular payment transaction is valid, if a beneficiary for a payment transaction is valid as well, and the like. In some embodiments, the computing platform 308 may access information from a transactions database that is stored and/or maintained by another computer system. The computing platform 308 may then perform validation of the data regarding a payment transaction by comparing the data for the payment transaction with the information obtained from the transaction database. In one or more embodiments, the computing platform 308 may access data regarding financial standards (e.g., local, national, or international regulations) in a database and compare and/or validate payment transaction data with the data regarding the financial standards. Validation may allow the system to determine if the payment transactions include all of the information needed for payment processing.

Computing platform 308 may identify one or more rejected payment transactions in the plurality of payment transactions based on the data regarding payment transactions for the client account. The computing platform 308 may analyze each of the plurality of payment transactions to identify one or more unrecoverable errors and/or other recoverable errors that may be repaired. In some embodiments, the computing platform 308 alternatively may categorize each payment transaction that has at least one of an unrecoverable error or a recoverable error as a rejected payment transaction (e.g., if the applicable client settings are set for “no repair”).

If the computing platform 308 validates the payment transactions, then the method proceeds to step 412, where the computing platform 308 may calculate the total transaction amount and use this information to initiate the proper accounting entries. That is, the computing platform 308 might not reject any payments in the plurality of payment transactions. Thus, at step 412, the computing platform 308 may debit or credit the client for the total transaction amount (e.g., an amount corresponding to the plurality of payment transactions). The computing platform 308 may debit or credit an amount to the client account, create an account entry for the amount which is debited or credited to the client account, and present the debited or credited amount as a single accounting entry in the client's account based on the client's settings.

If one or more payment transactions fail validation by the computing platform 308, then the method proceeds to step 414, where the computing platform 308 may check if the client or the financial institution has set up a setting for repair. For example, the client may have previously determined specific settings for handling payment transactions that do not pass validation (e.g., payment transactions with unrecoverable and/or recoverable errors). For example, some clients may prefer for failed payment transactions to be repaired, whereas other client might not prefer for failed payment transactions to be repaired. If the client or financial institution has not set up a setting for repair, then the method proceeds to step 416, where the computing platform 308 may reject one or more payment transactions that previously failed validation prior to accounting. If the client or financial institution has in fact set up a setting for repair, then the method proceeds to step 418. For example, the financial institution may set a setting for not repairing large volume files. At step 418, the computing platform 308 may designate one or more payment transactions that previously failed validation for repair. That is, the computing platform 308 may identify one or more payment transactions that previously failed validation to be repaired. For example, computing platform 308 may initiate a repair for each of the one or more payment transactions that previously failed validation. In some embodiments, an employee of the financial institution associated with workstation 302 may manually repair payment transactions. In one or more embodiments, the computing platform 308 may repair payment transactions automatically by performing and/or utilizing one or more payment enrichment processes set up by the financial institution.

In some embodiments, computing platform 308 may include the amount associated with each of the one or more failed payment transactions (which are being repaired) in the total for generating accounting entries. For example, the computing platform 308 may provide information regarding the rest of the payment transactions to the client even if one or more of the payment transactions previously failed validation and/or are currently undergoing repair or are about to be repaired by computing platform 308.

At step 419, the computing platform 308 may determine if the payment transaction was properly repaired. If the transaction was not successfully repaired (e.g., due to an unrecoverable error), then the method may proceed to step 420 in which the computing platform 308 and/or smart gross processing module 320 may reverse the corresponding accounting entry in the client account. That is, the client may have already been debited or credited the amount associated with a payment transaction that previously failed validation. Thus, computing platform 308 and/or smart gross processing module 320 may adjust the client account accordingly (e.g., by applying an adjustment entry to the client account for crediting an amount back to the client). At step 422, the computing platform 308 and/or smart gross processing module 320 may thus reject the payment transaction because was the error was irrepairable (e.g., due to an unrecoverable error).

If the transaction was successfully repaired at step 419, then the method may proceed to step 424, in which the computing platform 308 may determine if the transaction was repaired within the same day or within a predefined timeframe. It will be appreciated that the computing platform 308 may check if the transaction is repaired within the same day, within the next day, or within any other predefined time frame. If the transaction was not repaired within the same day, then the method may proceed to step 426, in which the computing platform 308 and/or smart gross processing module 320 may reverse the accounting entry in the client account and create one or more new accounting entries and continue processing the payment transaction.

At step 424, if the computing platform 308 repaired the payment transaction within the same day or within the predefined timeframe, then the method may proceed to step 430 illustrated in the method shown in FIG. 4B. At step 430, the computing platform 308 may check compliance of each of the plurality of payment transactions with regulations and sanctions. For example, information regarding the regulations and sanctions may be stored in one or more databases, and the computing platform 308 may access the one or more databases to check compliance of each of the plurality of payment transactions with the information regarding the regulations and sanctions. In some embodiments, compliance checking may occur at any point in the flow of method steps described in FIGS. 4A and 4B and/or may occur at multiple points in the process.

If the payment transactions pass compliance, then the method may proceed to step 432, in which the computing platform 308 may determine if the client account has enough funds to fulfill the payment transactions. If there are enough funds, then the method continues to step 434 in which the computing platform 308 continues processing of the payment transactions. If there are not enough funds, then the method continues from step 432 to step 436, in which the computing platform 308 rejects the payment transaction. In some cases, the computing platform 308 may perform multiple checks (e.g., any number of checks) to identify whether or not there are enough funds to process the payment transactions.

If the payment transactions do not pass compliance, then the method may proceed to step 440 in which the computing platform 308 may further analyze the payment transactions in reference to the regulations and sanctions. For example, the computing platform 308 may reassess the payment transactions to identify if the payments are acceptable and compliant. That is, the computing platform 308 may determine if data regarding the payment transactions comply or meet a set of standards (e.g., values of predefined metrics set by the financial institution or by government regulations). After reassessing for compliance at step 440, the computing platform 308 may accept the payment transactions (at step 442), reject the payment transactions (at step 448), or seize funds associated with the payment transactions (at step 454).

For example, if the payment transactions are valid and/or compliant, at step 442, the computing platform 308 may accept the payment transactions and continue processing at steps 444, 434, and/or 446. At step 444, the computing platform 308 may determine if the client account has enough funds to fulfill the payment transactions. If there are enough funds, then the method continues to step 434 in which the computing platform 308 may continue processing of the payment transactions. If there are not enough funds, then the method continues from step 444 to step 452, in which the computing platform 308 may perform reverse accounting of the payment transaction.

If the payment transactions are invalid and/or non-compliant, at step 448, the computing platform 308 may reject the payment transactions and continue processing at steps 450, 452, and 446. That is, computing platform 308 may reject the payment transaction, and the computing platform 308 may perform reverse accounting to return funds to the client account (e.g., at steps 452 and 446). If the computing platform 308 cannot successfully process the payment transaction (e.g., due to incompliance with sanctions), at step 454, the computing platform 308 may seize the payment transaction and funds of the client account (at steps 456 and 458). That is, the computing platform 308 might not return the funds to the client and may instead allow the funds to be held by the financial institution and/or the appropriate authorities.

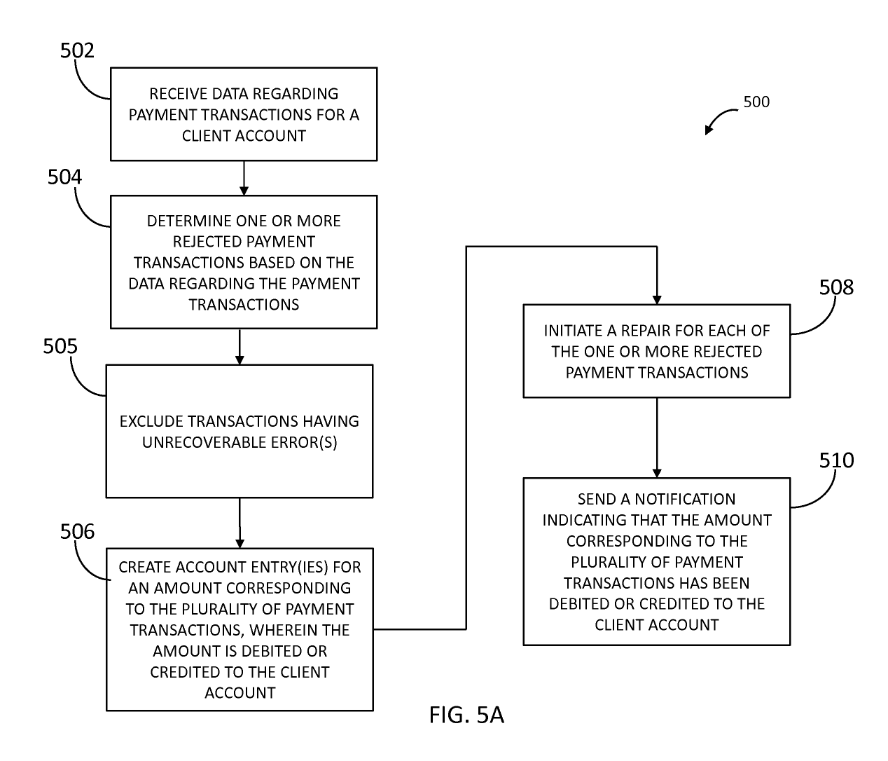

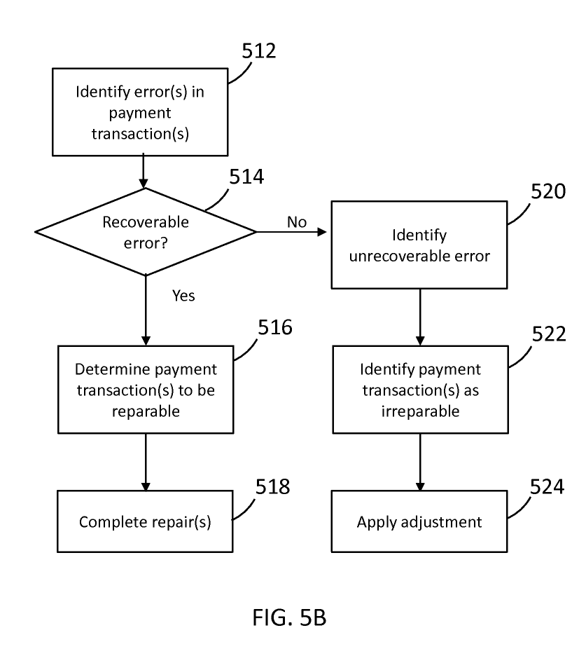

FIGS. 5A and 5B illustrate flowcharts that depict methods of smart gross management of repairs and exceptions for payment processing according to one or more illustrative aspects of the disclosure. In some embodiments, the example methods illustrated in FIGS. 5A and 5B may be performed by a computing device, which may include and/or implement one or more aspects of computing device 101. In additional and/or alternative embodiments, the example methods illustrated in FIGS. 5A and 5B may be performed by a computer system, such as a server computer system that is owned, operated, and/or controlled by a financial institution (which may, e.g., maintain the computer system in a back office or data center to process and repair payments for smart gross processing), and such a computer system may include one or more computing devices that include and/or implement one or more aspects of computing device 101 and/or computing platform 308. In other embodiments, the example methods illustrated in FIGS. 5A and 5B may be implemented in and/or may otherwise be embodied in computer-readable instructions that may be stored in a non-transitory computer-readable medium, such as a memory (disk drive, hard drive, solid state memory, optical drive, and the like).

As seen in FIG. 5A, the method may be initiated at step 502, in which a computing device (e.g., computing platform 308) may receive data regarding a plurality of payment transactions for a client account in a financial institution from one or more workstations 302. Each of the workstations 302 may be associated with a client or an employee of the financial institution. Data regarding the plurality of payment transactions may include account information, such an amount for each of the payment transactions, account number, client name, client address, and the like. In some embodiments, the workstations 302 may correspond to different work groups in the financial institution, and employees in the different work groups may send data regarding the plurality of payment transactions to the computing platform 308.

At step 504, the computing device (e.g., computing platform 308) may determine one or more rejected payment transactions in the plurality of payment transactions based on the data regarding payment transactions for the client account. For example, computing platform 308 may analyze and/or parse data regarding each of the plurality of payment transactions to identify one or more unrecoverable errors and/or one or more recoverable errors that may be repaired. The computing platform 308 may categorize each payment transaction that has at least one of an unrecoverable error or a recoverable error as a rejected payment transaction. That is, the computing platform 308 may store data associating each payment transaction that has an unrecoverable error or a recoverable error as a rejected payment transaction. At step 505, the computing device (e.g., computing platform 308) may exclude one or more transactions having unrecoverable errors. For example, the computing platform 308 may exclude one or more payment transactions with unrecoverable errors from the plurality of payment transactions, for purposes of creating one or more account entries, as illustrated below. At step 506, the computing device (e.g., computing platform 308) may create one or more account entries for an amount corresponding to the plurality of payment transactions (which may, e.g., be an amount corresponding to the original plurality of payment transactions minus an amount corresponding to the one or more excluded transactions having the unrecoverable errors), and the computing device may debit or credit the amount to the client account. For instance, even after identifying one or more errors in the plurality of payment transactions, the computing device may debit or credit the client account with the total amount for the plurality of payment transactions (e.g., the total amount for the plurality of payment transactions minus the amount(s) corresponding to the transactions having unrecoverable errors). For example, the computing device may create an account entry to debit or credit the client account for the total amount corresponding to the plurality of payment transactions, excluding the amount corresponding to transaction(s) having the one or more unrecoverable errors.

At step 508, the computing device (e.g., computing platform 308) may initiate a repair for each of the one or more rejected payment transactions in the plurality of payment transactions. For example, the computing device may initiate a process for repair of one or more rejected payment transactions, and the process may consist of several steps including checking client settings for repair and/or the financial institution's settings for repair, confirming duplicate accounting, confirming validation, and confirming compliance of the repaired payment transactions. At step 510, the computing device (e.g., computing platform 308) may send a notification indicating that the amount corresponding to the plurality of payment transactions (which may, e.g., exclude one or more transactions having unrecoverable errors, as illustrated above) has been debited or credited to the client account. For example, computing platform 308 may send a notification to one or more workstations 302, where the one or more workstations 302 are associated with a specific work group of employees or employees within a particular department in a financial institution.

Furthermore, the flowchart in FIG. 5B depicts additional methods of smart gross management of repairs and exceptions for payment processing according to one or more illustrative aspects of the disclosure. As seen in FIG. 5B, the method may be initiated at step 512, in which a computing device (e.g., computing platform 308) may identify one or more errors in at least one of a plurality of payment transactions, and the one or more errors may include at least one of an unrecoverable error or a recoverable error. For example, computing platform 308 may analyze and/or parse data regarding each of the plurality of payment transactions to identify one or more unrecoverable errors and/or other recoverable errors that may be repaired. After identifying that there is at least one error in the plurality of payment transactions, at step 514, the computing device may determine if the at least one error is a recoverable error. If the error is recoverable, then the method in this example proceeds to step 516, in which the computing device may determine the payment transaction with the recoverable error to be repairable. For example, based on identifying the existence of the recoverable error, the computing device may determine that the payment transaction is repairable and may identify a specific repair to fix the issue in the payment transaction. At step 518, the computing device may initiate and complete the repair for each of the payment transactions. That is, the computing device may repair each of the rejected payment transactions.

If the error is not recoverable, then the method in this example proceeds from step 514 to step 520, in which the computing device may identify the error as unrecoverable. That is, the computing device may store data (e.g., in a transactions database) identifying the particular payment transaction as a payment transaction with an unrecoverable error. At step 522, the computing device may identify one or more rejected payment transactions as irrepairable payment transactions based on the rejected payment transactions having at least one unrecoverable error. At step 524, the computing device may apply an adjustment for each of the irrepairable payment transactions. The computing device may apply an adjustment by posting an entry (e.g., a monetary amount) to a corresponding client account for an irrepairable payment transaction. That is, the computing device may post a credit to the client account to reverse a payment transaction which was previously accounted for. For example, the computing device may have previously operated on the assumption that all transactions may be repaired; however, after identifying payments as irrepairable, the computing device may account for the irrepairable payments by applying an adjustment to the client account.

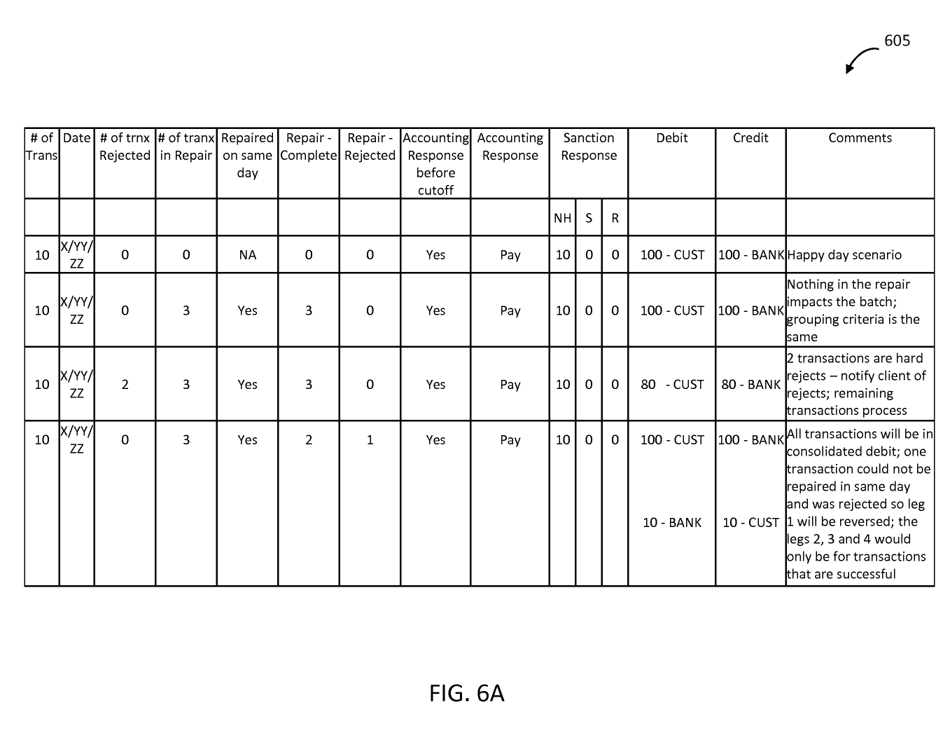

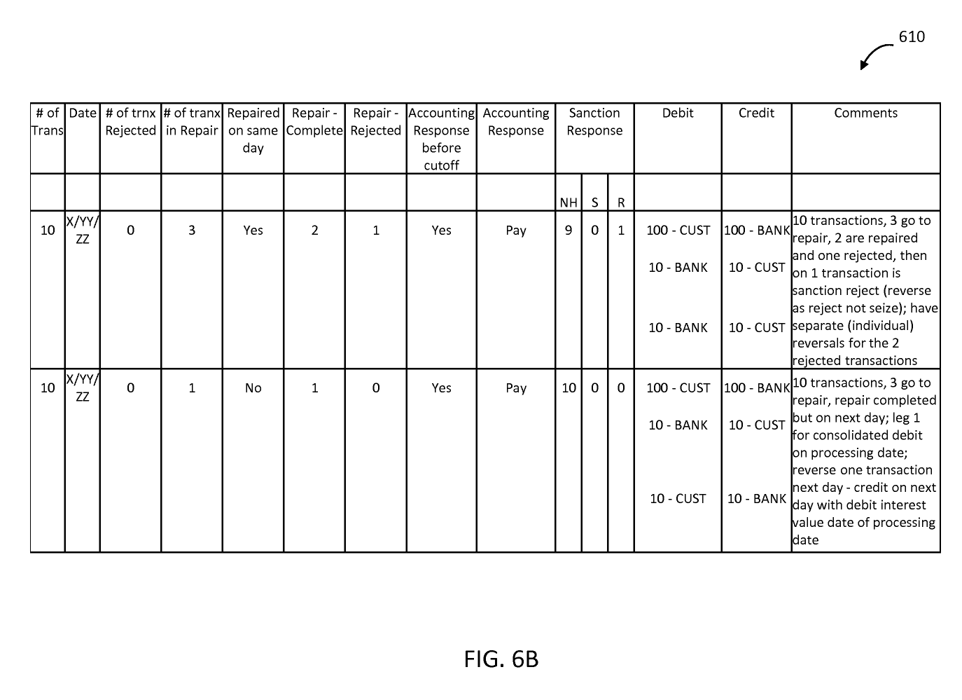

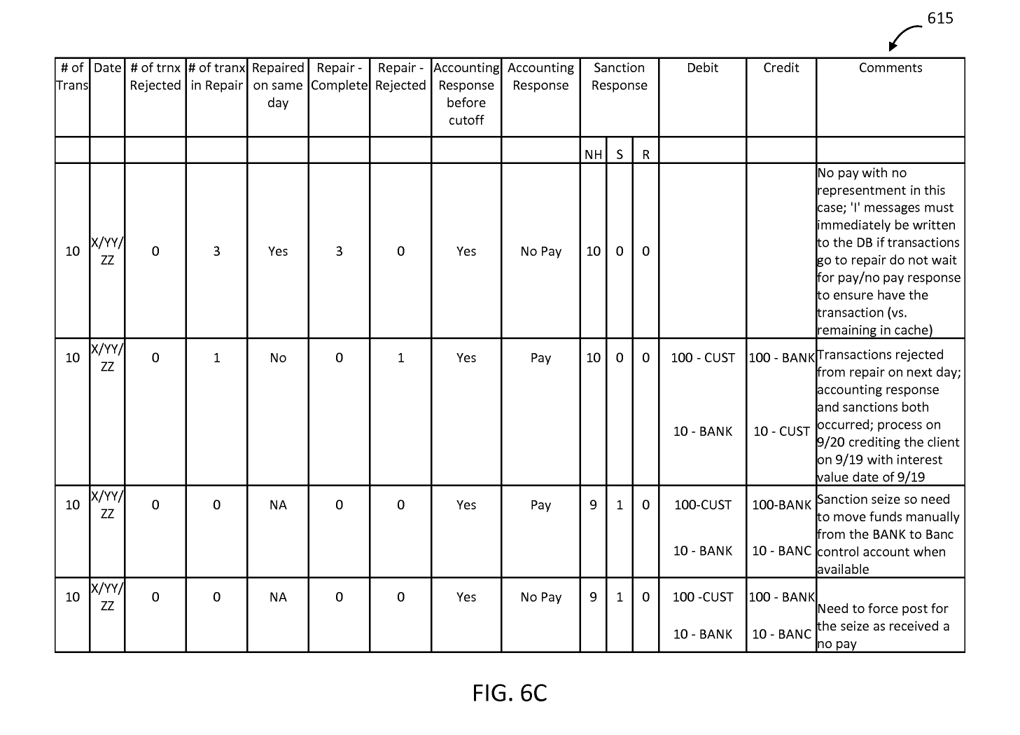

FIGS. 6A, 6B and 6C depict an illustrative tables 605, 610, and 615 that include example data associated with smart gross management of repairs and exceptions for payment processing in accordance with one or more example embodiments. Tables 605, 610, and 615 illustrate example information compiled upon payment processing and repairs for a plurality of payments. Each line in the tables may correspond to a group of transactions from a client (e.g., 10 transactions), and each table illustrates various scenarios for direct debit or credit transfer transactions between a financial institution (e.g., a bank) and a client (e.g., a customer). The date column in tables 605, 610, and 615 may include one or more dates for each group of transactions. For example, the one or more dates may include processing dates, values dates, accounting dates, and/or the like. Although not shown, tables 605, 610, and 615 may include other information such as one or more columns designating scenarios, amounts, and the like. The tables may also indicate whether or not transaction(s) include bulk accounting, whether or not an accounting response associated with one or more transactions is submitted and/or received before a cut-off date, whether or not a sanction response associated with one or more transactions is submitted and/or received before a cut-off date, and the like.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims are included in the scope of the present disclosure. For example, the steps illustrated in the illustrative figures may be performed in other than the recited order, and one or more steps illustrated may be optional in accordance with aspects of the disclosure.

What is claimed is:

1. A computing device, comprising:
at least one processor;
a communication interface; and
a memory storing instructions that when executed by the at least one processor cause the computing device to:
receive, by the at least one processor, via the communication interface and from one or more computing devices, data regarding a plurality of payment transactions for a client account in a financial institution;
determine, by the at least one processor, one or more rejected payment transactions in the plurality of payment transactions based on the data regarding payment transactions for the client account;
create, by the at least one processor, an account entry for an amount corresponding to the plurality of payment transactions, wherein the amount is debited to the client account;
initiate, by the at least one processor, a repair for each of the one or more rejected payment transactions in the plurality of payment transactions; and
send, by the at least one processor, via the communication interface and to the one or more computing devices, a notification indicating that the amount corresponding to the plurality of payment transactions has been debited to the client account.

2. The computing device of claim 1, wherein the memory stores additional instructions that, when executed by the at least one processor, cause the computing device to:
identify, by the at least one processor, one or more errors in at least one of the plurality of payment transactions, wherein the one or more errors comprises at least one of an unrecoverable error or a recoverable error.

3. The computing device of claim 2, wherein the unrecoverable error comprises at least one of a duplicate payment transaction or a non-existent account number for a transaction.

4. The computing device of claim 2, wherein the recoverable error comprises an at least one of incorrect routing information or incomplete routing information.

5. The computing device of claim 1, wherein the memory stores additional instructions that, when executed by the at least one processor, cause the computing device to:
identify, by the computing device, whether each of the one or more rejected payment transactions are repairable.

6. The computing device of claim 1, wherein the memory stores additional instructions that, when executed by the at least one processor, cause the computing device to:
identify, by the computing device, at least one recoverable error for repair for each of the one or more rejected payment transactions;
determine, by the computing device, each of the one or more rejected payment transactions to be repaired based on the at least one recoverable error; and
complete, by the computing device, the repair for each of the one or more rejected payment transactions.

7. The computing device of claim 1, wherein the memory stores additional instructions that, when executed by the at least one processor, cause the computing device to:
identify, by the computing device, at least one unrecoverable error for each of the one or more rejected payment transactions;
identify, by the computing device, one or more rejected payment transactions as irrepairable payment transactions based on the rejected payment transactions having at least one unrecoverable error; and
apply, by the computing device, an adjustment for each of the irrepairable payment transactions, wherein a credit is posted to the client account.

8. The computing device of claim 1, wherein the memory stores additional instructions that, when executed by the at least one processor, cause the computing device to:
determine, by the computing device, that the repair for each of the one or more rejected payment transactions has been completed.

9. The computing device of claim 1, wherein creating the account entry for the amount corresponding to the plurality of payment transactions is based on an expectation that the one or more rejected payment transactions will be cleared in a predetermined period of time.

10. The computing device of claim 9, wherein the predetermined period of time comprises a window of time for clearing payment transactions set by the financial institution.

11. The computing device of claim 1, wherein the rejected payments are rejected for at least one of incorrect routing information or incomplete routing information for the client account.

12. The computing device of claim 1, wherein the repair for each of the one or more rejected payment transactions comprises at least one of processing client account information, validating payments, or correcting routing information for the client account.

13. A method, comprising:
receiving, by a computing device comprising at least one processor and a communication interface, via the communication interface and from one or more computing devices, data regarding a plurality of payment transactions for a client account in a financial institution;
determining, by the computing device, one or more rejected payment transactions in the plurality of payment transactions based on the data regarding payment transactions for the client account;
creating, by the computing device, an account entry for an amount corresponding to the plurality of payment transactions, wherein the amount is debited to the client account;
initiating, by the computing device, a repair for each of the one or more rejected payment transactions in the plurality of payment transactions; and
sending, by the computing device, via the communication interface and to the one or more computing devices, a notification indicating that the amount corresponding to the plurality of payment transactions has been debited to the client account.

14. The method of claim 13, further comprising:
identifying, by the computing device, at least one recoverable error for repair for each of the one or more rejected payment transactions;
determining, by the computing device, each of the one or more rejected payment transactions to be repaired based on the at least one recoverable error; and
completing, by the computing device, the repair for each of the one or more rejected payment transactions.

15. The method of claim 13, further comprising:
identifying, by the computing device, at least one unrecoverable error for each of the one or more rejected payment transactions;
identifying, by the computing device, one or more rejected payment transactions as irrepairable payment transactions based on the rejected payment transactions having at least one unrecoverable error; and
applying, by the computing device, a credit for each of the irrepairable payment transactions, wherein the credit is posted to the client account.

16. The method of claim 13, further comprising:
determining, by the at least one processor, that the repair for each of the one or more rejected payment transactions has been completed.

17. The method of claim 16, wherein the determining the one or more rejected payment transactions comprises:
identifying one or more errors in at least one of the plurality of payment transactions, wherein the one or more errors comprises at least one of an unrecoverable error or a recoverable error.

18. The method of claim 17, wherein the unrecoverable error comprises at least one of a duplicate payment transaction or a non-existent account number for a transaction, and wherein the recoverable error comprises an at least one of incorrect routing information or incomplete routing information.

19. The method of claim 16, wherein initiating the repair for each of the one or more rejected payment transactions comprises:
determining whether each of the one or more rejected payment transactions are repairable.

20. One or more non-transitory computer-readable media storing instructions that, when executed by at least one computing device, cause the at least one computing device to:
receive data regarding a plurality of payment transactions for a client account in a financial institution;
determine one or more rejected payment transactions in the plurality of payment transactions based on the data regarding payment transactions for the client account;
create an account entry for an amount corresponding to the plurality of payment transactions, wherein the amount is debited to the client account;
initiate a repair for each of the one or more rejected payment transactions in the plurality of payment transactions; and
send a notification indicating that the amount corresponding to the plurality of payment transactions has been debited to the client account.
